(19) United States
(12) Patent Application Publication
(10) Pub. No.: US 2022/0383094 A1
(43) Pub. Date: Dec. 1, 2022

(54) SYSTEM AND METHOD FOR OBTAINING RAW EVENT EMBEDDING AND APPLICATIONS THEREOF

(71) Applicant: YAHOO ASSETS LLC, DULLES, VA (US)

(72) Inventors: Ruichen Wang, Champaign, IL (US); Jian Tian, Champaign, IL (US); Mingzhe Zhao, Champaign, IL (US)

(21) Appl. No.: 17/331,810

(22) Filed: May 27, 2021

(51) Int. Cl. G06N 3/08; G06N 3/04; G06Q 30/02; G06F 40/279

(52) U.S. Cl. CPC G06N 3/08; G06N 3/04; G06Q 30/0204; G06Q 30/0277; G06F 40/279

(57) ABSTRACT

The present teaching relates to method, system, medium, and implementations for learning embeddings. Upon receiving raw event data recording information related to a plurality of events, at least one attribute associated with each of the plurality of events is identified from the raw event data, wherein the at least one attribute represent characteristics associated with the event. The plurality of events are grouped into one or more aggregated groups in accordance with an aggregation criterion, defined with respect to at least some of the attributes identified from the events. Each aggregated group includes some events that satisfies the aggregation criterion which are used to create an event sequence, which includes the events in the aggregated group and one or more gaps each of which separates a pair of adjacent events in the at least one event. The created event sequences are then provided to an artificial neural network (ANN) to learn event embeddings.

### BACKGROUND

### 1. Technical Field

The present teaching generally relates to computer. More specifically, the present teaching relates to machine learning.

### 2. Technical Background

Since the inception of the Internet, more and more data have been digitized and made available on the network at the fingertips of people and more and more commercial activities have been migrated to online. Such big data led to the development of sophisticated data analytic techniques to mine characteristics, relationships, patterns, and knowledge embedded in such big data. For example, data related to events occurred due to online activities may be explored to learn, e.g., which groups of user with certain demographics like what types of products, which online publishers yields more conversions and at what time frame, typical behavior patterns of certain fraudulent activities in online commercial advertisements, etc. Such event data may include different parts, as illustrated in FIG. 1A.

As illustrated, an event may involve some entities, an act, and optionally additional peripheral information. For instance, an online activity of a user on a mobile browser clicking an advertisement displayed on, e.g., Yahoo Finance, may correspond to an event, which has three entities, i.e., the user, the advertisement, and the platform Yahoo Finance. It also includes an act, i.e., clicking, and a user agent (UA), i.e., the mobile browser. FIG. 1B shows representations of some exemplary events E1, . . . , Ei, . . . , Ek, each of which includes entities (e.g., user, Ad), act (Op or operation), UA, . . . , T (time stamp). Due to the high traffic on the Internet, the data volume collected on online event is vast. Many techniques have been developed to analyze such event data and gain insights of such data to benefit future operations.

Event data need to be represented in a form that can be processed. Different relationships implied in an event may be represented using graphs. For example, events may reveal about who (users) tends to do what (click on advertisements) with respect to what (types of advertisements) on what platform (YouTube, Yahoo Finance, or Google) and at what time (day or evening). Capturing such relationships from events are often crucial in data mining. In addition, different events along a temporal direction may also be important and use to infer other relationships. Traditionally, event data may be represented using graphs and a series of events in time may be represented as sequences.

In a graph representation, each node in the graph may correspond one aspect of the event (e.g., user, UA, etc.) and each edge linking two nodes in the graph represents a relationship between two nodes. One example is shown in FIG. 1C, where event E1 as shown in FIG. 1B is represented by different pairs of nodes and each pair represents a simple relationship. For instance, (User 1, Op 1) represents user 1 performed operation 1; (user 1, Ad. 1) represents user 1 acted on advertisement 1; (Op 1, Ad. 1) represents that operation 1 is performed on advertisement 1; . . . , etc. FIG. 1D (PRIOR ART) illustrates how a graph representation of event E1 is constructed based on such low dimension edges. Although the entire graph may reveal different relationships, the edges representing only two nodes are what is processed. Even though there may be more complex relationships in an event, e.g., user 1 clicks an advertisement displayed on YouTube at 10:00 pm, the nature of low dimensionality of graph edges fail to capture such relationships with a higher dimension. The information lost due to the inability of representation will undoubtedly lead of quality of analytical result.

Deep learning has been employed to learn from data via, e.g., embedding in a variety of applications such as word embedding. Embedding process is to learn continuous vectors from discrete or categorical variables via learning. Thus, an embedding is a mapping from discrete or categorical variable to a vector of continuous numbers and is a learned continuous vector representation of given discrete variables. Event data correspond to discrete/categorical variables can be used for deep learning to derive embeddings representing continuous vectors of such discrete/categorical variables. To learn adequately, the discrete/categorical variables and full relationship thereof need to be adequately represented to enable effective embedding learning. Due to the deficiency of current graph representation of events, the embedding learning from such event data is limited. Thus, there is a need for an improve approach to overcome the deficiencies of the state of the art.

### SUMMARY

The teachings disclosed herein relate to methods, systems, and programming for text processing. More particularly, the present teaching relates to methods, systems, and programming related to raw text structuring.

In one example, a method, implemented on a machine having at least one processor, storage, and a communication platform capable of connecting to a network for event embedding. Upon receiving raw event data recording information related to a plurality of events, at least one attribute associated with each of the plurality of events is identified from the raw event data, wherein the at least one attribute represent characteristics associated with the event. The plurality of events are grouped into one or more aggregated groups in accordance with an aggregation criterion, defined with respect to at least some of the attributes identified from the events. Each aggregated group includes some events that satisfies the aggregation criterion which are used to create an event sequence, which includes the events in the aggregated group and one or more gaps each of which separates a pair of adjacent events in the at least one event. The created event sequences are then provided to an artificial neural network (ANN) to learn event embeddings.

In a different example, a system for learning event embedding is disclosed and that includes an identifier, an event data aggregator, an event sequence creator, and an artificial neural network (ANN). The identifier, upon receiving raw event data recording a plurality of events, identifies attributes associated with each of the events from the received raw event data, where the attributes represent characteristics of each event. The event data aggregator groups the plurality of events into one or more aggregated groups in accordance with an aggregation criterion, defined with respect to some attributes identified, where each aggregated group includes events that satisfy the aggregation criterion. The event sequence creator then creates, for each aggregated group, an event sequence including events from the aggregated group and one or more gaps that separate each pair of adjacent events in the aggregated group. The ANN is provided with such created event sequences to learn event embeddings.

Other concepts relate to software for implementing the present teaching. A software product, in accord with this concept, includes at least one machine-readable non-transitory medium and information carried by the medium. The information carried by the medium may be executable program code data, parameters in association with the executable program code, and/or information related to a user, a request, content, or other additional information.

In one example, a machine-readable, non-transitory and tangible medium having information recorded thereon for event embedding. When the information is read by the machine, it causes the machine to perform various steps. Upon receiving raw event data recording information related to a plurality of events, at least one attribute associated with each of the plurality of events is identified from the raw event data, wherein the at least one attribute represent characteristics associated with the event. The plurality of events are grouped into one or more aggregated groups in accordance with an aggregation criterion, defined with respect to at least some of the attributes identified from the events. Each aggregated group includes some events that satisfies the aggregation criterion which are used to create an event sequence, which includes the events in the aggregated group and one or more gaps each of which separates a pair of adjacent events in the at least one event. The created event sequences are then provided to an artificial neural network (ANN) to learn event embeddings.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A-1D (PRIOR ART) illustrate event data and state of the art event representation;

FIG. 2A presents exemplary hypergraph representations of different events associated with a user, in accordance with an exemplary embodiment of the present teaching;

FIG. 2B shows mapping a sequence of related events to a sentence, in accordance with an exemplary embodiment of the present teaching;

FIG. 2C illustrates the concept of self-attention and its use in the context of event embedding among different entities, in accordance with an embodiment of the present teaching;

FIG. 3A depicts an exemplary framework for an event embedding based application system, in accordance with an exemplary embodiment of the preset teaching;

FIG. 3B illustrates exemplary types of applications that may be deployed based on event embeddings, in accordance with an embodiment of the present teaching;

FIG. 4A depicts an exemplary high level system diagram for a raw event embedding generator, in accordance with an exemplary embodiment of the present teaching;

FIG. 4B illustrates exemplary types of event aggregation criteria for generating groups of events, in accordance with an exemplary embodiment of the present teaching;

FIG. 4C shows an exemplary sequence of events with gaps between adjacent events, in accordance with an exemplary embodiment of the present teaching;

FIG. 5 is a flowchart of an exemplary process of a raw event embedding generator, in accordance with an exemplary embodiment of the present teaching;

FIG. 6A depicts an exemplary neural network architecture for learning raw event embedding, in accordance with an exemplary embodiment of the present teaching;

FIG. 6B depicts an exemplary self-attention neural network architecture for learning weights representing influences among entities, in accordance with an embodiment of the present teaching;

FIG. 6C depicts an exemplary self-attention neural network architecture for learning weights representing influences among entities, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

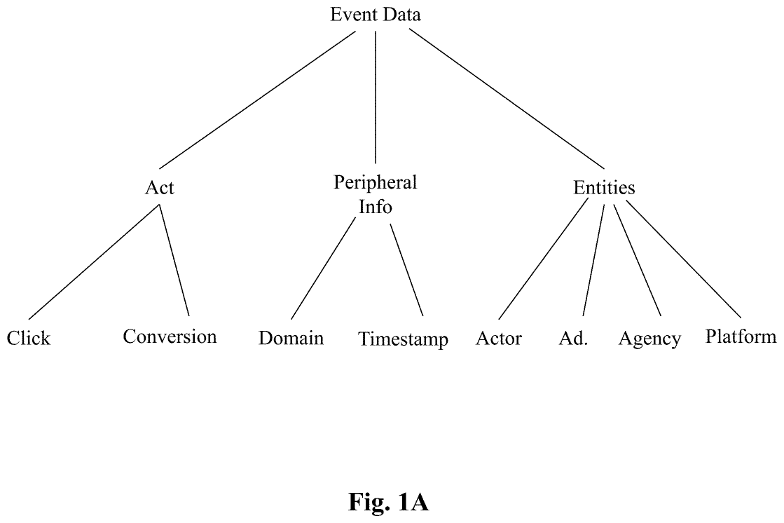

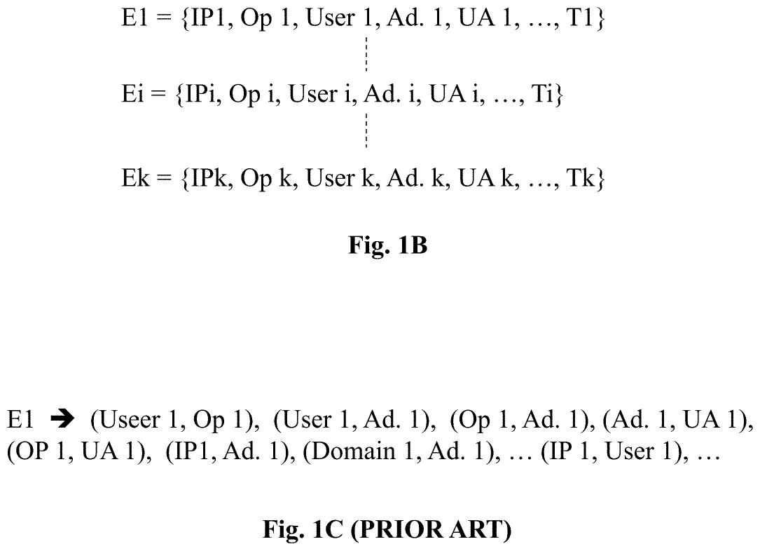

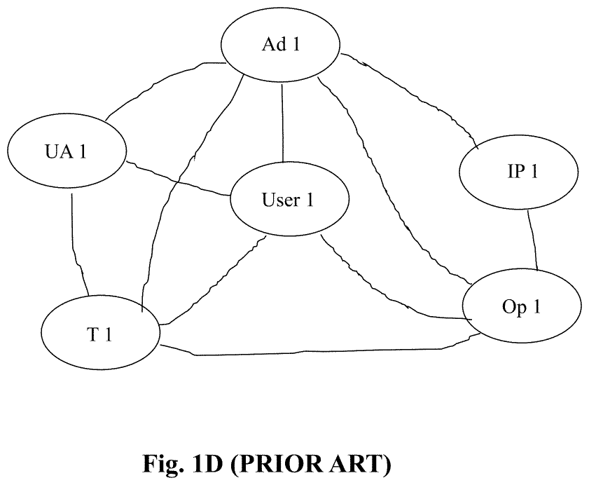

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching aims to enhance representations of events to enable more effective learning of event embeddings to allow more effectively applications using such learned event embeddings. Particularly, in some respects, the present teaching discloses representing events and/or a sequence of events using the construct of hypergraphs with hyperedges to capture high dimensional relationships exhibited in events. In a different aspect, the present teaching leverages the framework of word2vec embedding processing and maps each sequence of events to a sentence with each event as a word in the sentence and entities in an event as characters of a word. With the input being sequences of events mapped as sentences fed to a neural network architecture with self-attention mechanism, what is learned as output are embeddings of the input events. Each of the input events may be organized according to some criteria which may be determined based on needs. The resultant event embeddings may then be used for different applications or tasks and can be deployed in a manner suitable for the application.

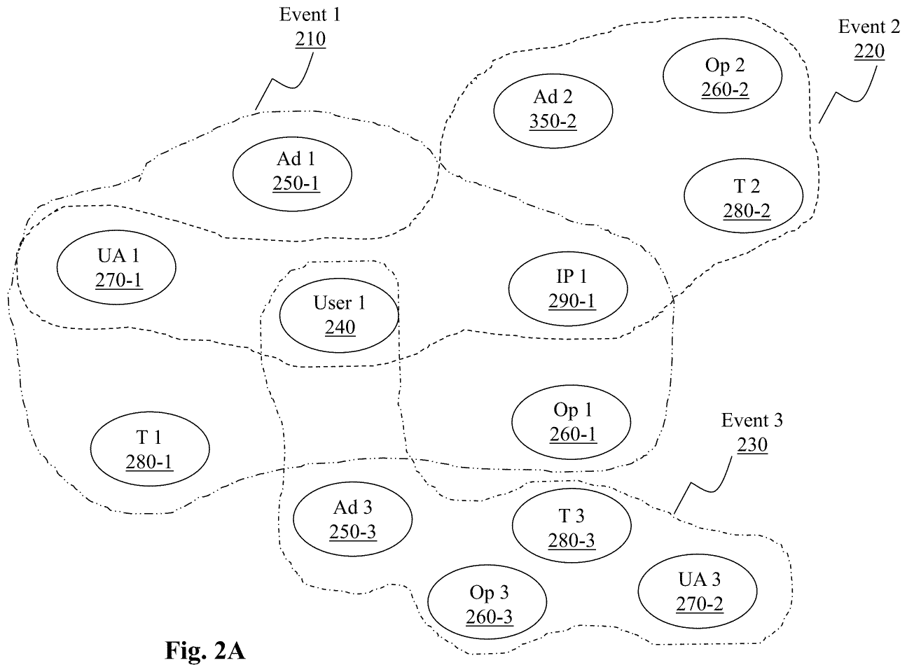

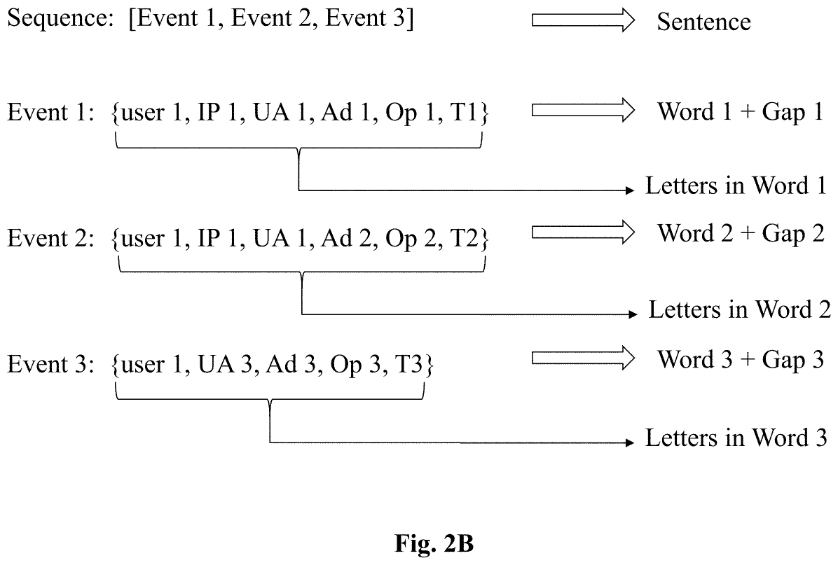

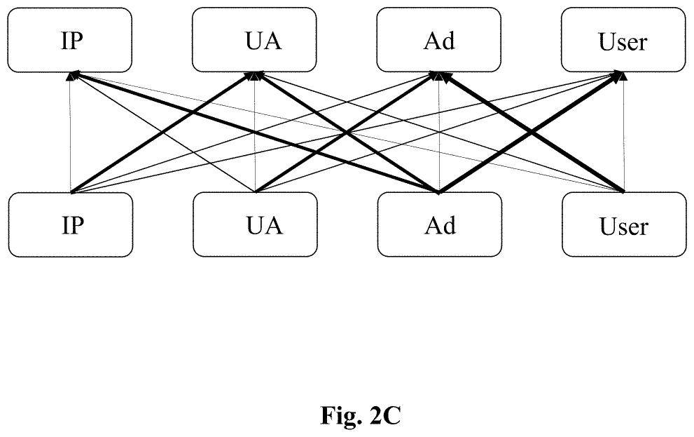

FIG. 2A presents an exemplary hypergraph representation for event, in accordance with an exemplary embodiment of the present teaching. This illustration is based on three example events, as shown in FIG. 2B, where a sequence involves three events [Event 1, Event 2, Event 3] involving the same user 1 or user 1 240. In FIG. 2B, it is illustrated that Event 1 is user 1 performed an operation Op 1 on advertisement Ad 1 on a user agent UA 1 represented by IP 1 at time T1; with Event 2, the user 1 performed an operation Op 2 on advertisement Ad 2 on the same user agent UA 1 represented by IP 1 at time T2; in Event 3, the user performed an operation Op 3 on advertisement Ad 3 on a user agent UA 3 at time T3.

Instead of representing each of different relationships in these events using a graph edge connecting only two entities, the present teaching discloses to represent each event using a hyperedge in a high dimensional space to link all entities in each event. The hypergraph is shown in FIG. 2A, where there are event 1 210, event 2 220, and event 3 230, that are all related to the same user or user 1 240. In Event 1 310, user 1 240 performed operation Op 1 260-1 on Ad 1 250-1 on UA 1 270-1 represented by address IP 1 290-1 at time T1 280-1. In event 2 220, user 1 240 performed Op 2 260-2 on Ad 2 250-2 on UA 1 270-1 represented by address IP 1 290-1 at time T2 280-2. In Event 3, the same user performed Op 3 260-3 on Ad 3 250-3 on UA 3 270-3 at time T3 280-3. Each event herein is represented by a hyperedge connecting all entities/aspects of the event. Because of the same user being involved, hyperedges representing these events are connected to form a hypergraph representing a sequence of three events.

As discussed herein, the present teaching utilizes the framework of text based learning such as word2vec for learning event embeddings. To do so, a sequence of events is mapped to a sentence with each word in the sentence corresponding to an event and each entity in an event corresponding to a letter of a word. FIG. 2B illustrated how to map a sequence of three events in a sequence to a sentence, in accordance with an exemplary embodiment of the present teaching. In this illustration, a sentence corresponding to the sequence of event has three words corresponding to three events and gaps between each pair of adjacent words. Specifically, the sentence has Word 1+Gap 1+Word 2+Gap 2+Word 3. Here, Word 1 corresponds to Event 1={User 1, IP 1, UA 1, Ad 1, Op 1, T1}; Word 2 corresponds to Event 2={user 1, IP 1, UA 1, Ad 2, Op 2, T2}; Word 3 corresponds to Event 3={user 1, UA 3, Ad 3, Op 3, T3}.

To learn event embeddings is to learn the relationships among different entities in a sequence of events and it is similar to learning word embeddings based on sentences. Each word in a sentence contributes or influences the meaning of other words in the sentence. Different words may have different degrees of influence depending on the context. When a sequence of events is mapped to a sentence, an event in a sequence may influence or contribute to other events in the sequence, and each entity in an event may influence or contribute to other entities in the events. FIG. 2C illustrates the concept of self-attention and its use in the context of event embedding among different entities, in accordance with an embodiment of the present teaching. In this illustration, both rows represent the same entities involved in an event and the two rows are connected, i.e., each of the entities is connected to every other entity in the event. The weights on the connections may be learned via learning and the learned weights signify the degree of influence.

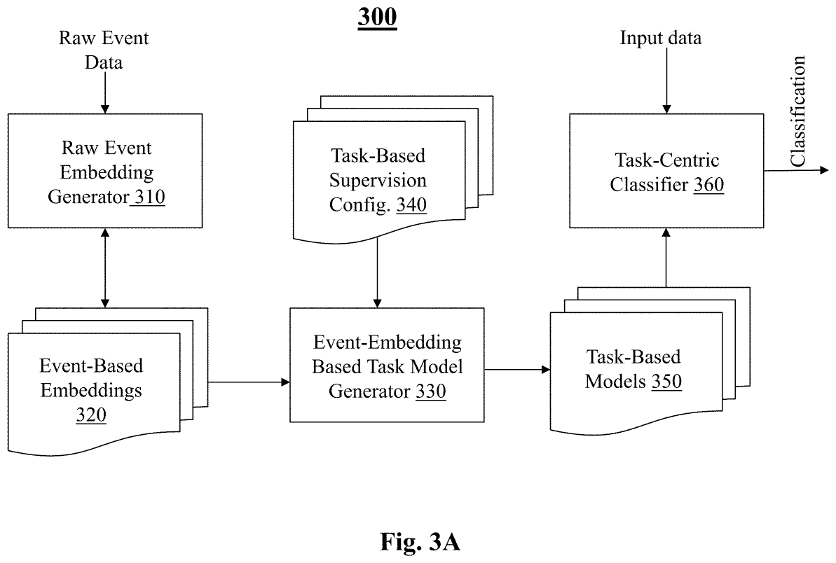

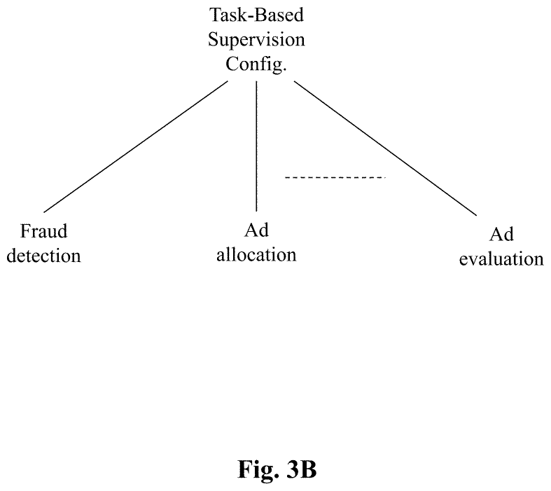

With raw events represented as discussed herein, input sequences of events (with gaps) may be provided to a neural network for learning the embeddings. FIG. 3A depicts an exemplary framework 300 for an event embedding based application system, in accordance with an exemplary embodiment of the preset teaching. The framework 300 is provided for learning event embeddings based on raw event data to result in event-based embeddings 320. Such learned event embeddings can be utilized by different applications. FIG. 3B illustrates exemplary types of applications that may be developed based on event embeddings, in accordance with an embodiment of the present teaching. As illustrated, event embeddings may be used in detecting fraud in online activities, which may include to identify sources of ad clicking as fraudulent operations. Event embeddings may also be used to detect different characteristics in online advertising, e.g., user preferences, evaluating effectiveness of advertisements in terms of different criteria such as users demographics, platforms, browsers, timeframes, etc. Such detected characteristics may be used to guide how resources related to advertising may be allocated in order to achieve maximum returns.

In the exemplary embodiment shown in FIG. 3A, the framework 300 comprises a raw event embedding generator 310, an even-embedding based task model generator 330, and a task-centric classifier 360. The raw event embedding generator 310 is provided to learn event embeddings based on raw event data and generates event-based embeddings 320. Based on the event-based embeddings 320, the event-embedding based task model generator 330 is provided for training task-based models 350 directed to specific tasks based on the event embeddings 320. The task can be arbitrarily defined and the model for the task may be appropriately trained based on suitably provided task-based supervision configuration 340 that may provide information needed to facilitate training the models for different specific tasks. For instance, the task-based supervision configuration 340 may provide, for each task, supervised information related to classification or ground truth. With such supervised information, the event-embedding based task model generator 330 may learn model parameters for classifying different event embeddings into different classes related to the tasks in hand and produce models 350 that may correspond to learned classification models. For instance, for fraud detection, the task-based supervision configuration 340 may provide information that may be used to obtain ground truth events that are either deemed as fraudulent online activities or normal (non-fraudulent) online events. In this case, such classified events may be used for training to derive the models 350 for detecting fraudulent online activities. With such models from 350 trained for specific tasks (e.g., fraud detection), the task-centric classifier 360 may, upon receiving input data, classify the input data based on appropriate models to output the classification.

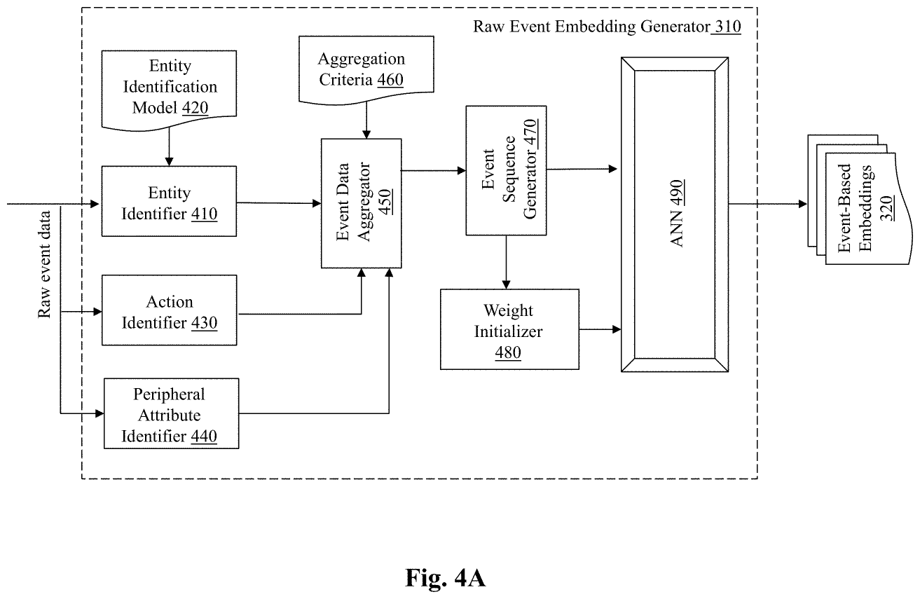

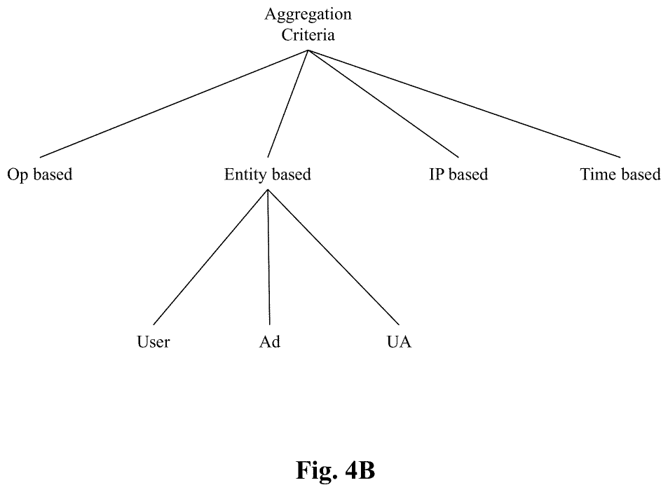

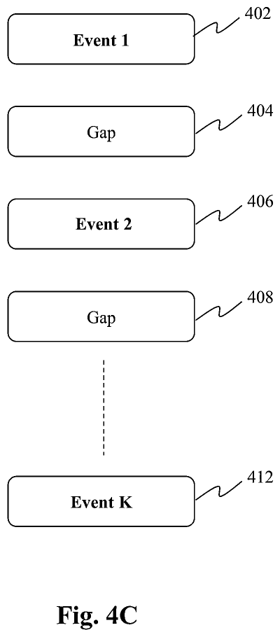

FIG. 4A depicts an exemplary high level system diagram for the raw event embedding generator 310, in accordance with an exemplary embodiment of the present teaching. As discussed herein, the raw event embedding generator 310 is configured to learn, from raw event data, their corresponding embeddings 320. To achieve that, the raw event embedding generator 310 comprises an entity identifier 410 for identifying entities from each event, an action identifier 430 for identifying an action involved in each event, a peripheral attribute identifier 440 for identifying various attributes related to the event such as UA, domain, etc., an event data aggregator 450 to aggregate events according to some aggregation criteria 460, an event sequence generator 470 for generating event sequences based on aggregated events, an artificial neural network (ANN) 490 for learning embeddings based on the sequences of events generated, and a weight initializer 480 for initializing the weights on connections of a self-attention network in the ANN 490.

As discussed herein, event data with identified entities, actions, and other peripheral attributes may be aggregated by the event data aggregator 450 to generate events in groups. Such aggregation may be performed based on different criteria 460 determined based on, e.g., application needs. FIG. 4B illustrates exemplary types of event aggregation criteria for generating groups of events, in accordance with an exemplary embodiment of the present teaching. For example, events may be aggregated based on specific entities such as users, advertisements, or user agents or UAs. A group of events related to a particular user may be used as training data to learn embeddings capturing certain characteristics of the user based on events involving the user. Similarly, advertisements may be used as aggregation criteria to group events according to different advertisements. In this case, a group of events corresponding to the same advertisement may provide information characterizing the performance of the advertisement with respect to, e.g., different users, different domains, IP address, or UAs. Aggregation may also be based on, e.g., operations or actions performed such as conversion, so that a group of events may provide insight on the conditions under which conversion may happen. IP addresses may also be used as a criterion for aggregating events that may show different event parameters associated with events occurred with respect to different IP addresses. In some instances, events may also be grouped in accordance with the times of occurrences of the events so that such generated groups of events may capture how actions are correlated with time, how users behave differently in different time frames, etc.

As discussed herein, for each group of events generated via aggregation, events in each group may be ordered as a sequence, e.g., as a time series with events spaced with gaps as discussed herein. This is performed by the event sequence generator 470. FIG. 4C shows an exemplary sequence of events with gaps between adjacent events, in accordance with an exemplary embodiment of the present teaching. As shown, events 1-K form a sequence with adjacent events separated by a gap. For example, event 1 402 is followed by a first gap 404, then event 2 406 followed by a second gap 408, . . . and event K 412. As discussed herein, in some embodiments, learning embeddings may be achieved by utilizing the ANN framework similar that for learning word embeddings based on input sentences. To do so, each sequence is treated as a sentence with each event/gap in the sequence being treated as a word and entities in each event as letters of a word. As such, the exemplary sequence shown in FIG. 4C corresponds to a sentence, with events (gaps) as words and entities in each event as letters. Such sequences of events are provided to the ANN 490 for learning embeddings, as shown in FIG. 4A.

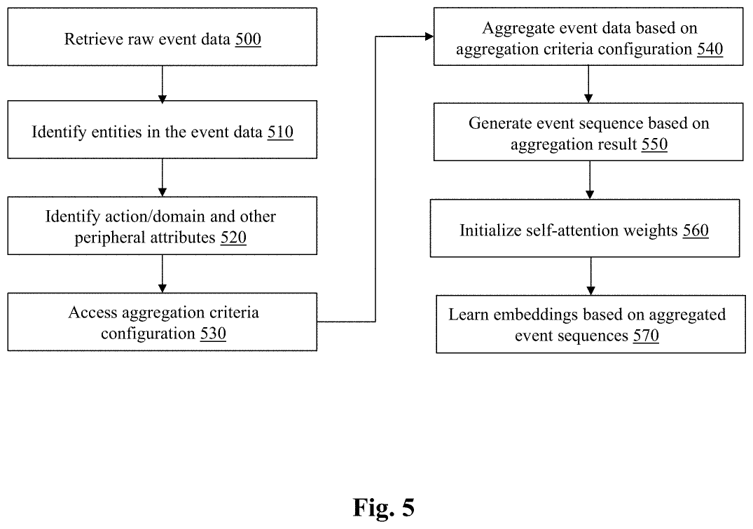

FIG. 5 is a flowchart of an exemplary process of the raw event embedding generator 310, in accordance with an exemplary embodiment of the present teaching. Raw event data are first obtained, at 500, and used by different processing units to extract relevant attributes from the event data. The entity identifier 410 identifies, at 510, entities from events based on event identification model 420. The action identifier 430 identifies, at 520, the actions in events while the peripheral attributes identifier 440 extracts other relevant attributes (e.g., UA, IP, time, etc.) from events. Events with such identified various attributes can then be aggregated, by the event data aggregator 450, by accessing, at 530, appropriate aggregation criteria from 460 to aggregate, at 540, the events into different groups of events. Each aggregated group of events is then used, by the event sequence generator 470, to generate a sequence of events at 550. The sequences of events are provided to the ANN 490 as training data to enable learning of event embeddings. As discussed herein, with the self-attention configuration of the ANN 490, as shown in FIG. 2C, weights are associated with each of the connection in the fully connected network. Such weights are learned during the training period based on weights initially assigned. This is performed by the weight initializer 480 at step 560. The initial weights assigned to different connections may be randomized or equal valued as starting points. During the training, the ANN 490 conducts machine learning, at 570, based on discrepancies between ground truth of the training data and the predictions made by the ANN 490 and adjust such weights in the self-attention network and other parameters involved in the ANN 490. Such adjustments are generally performed in iteration.

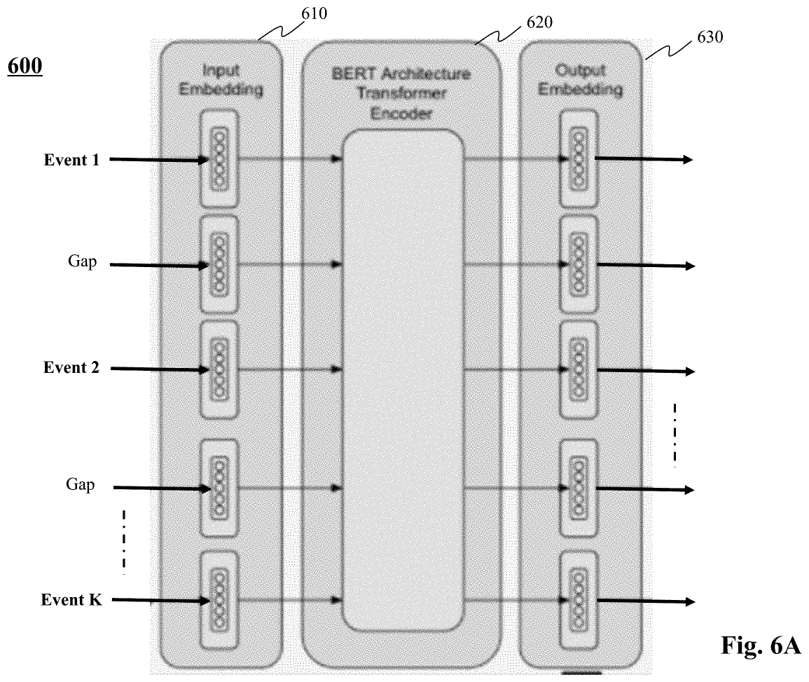

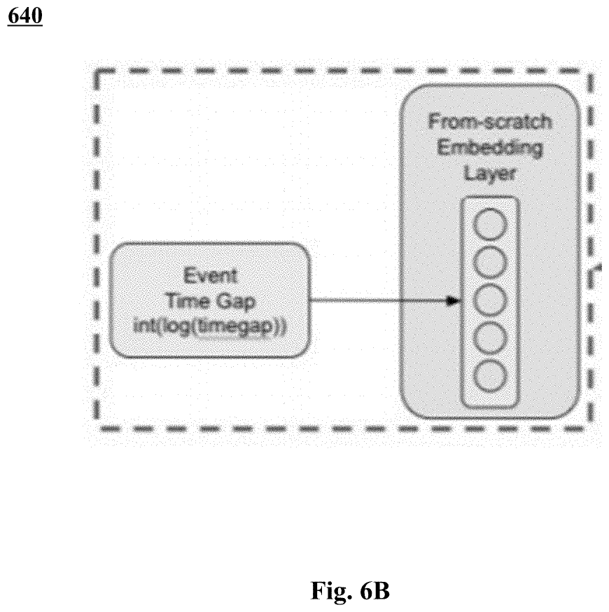

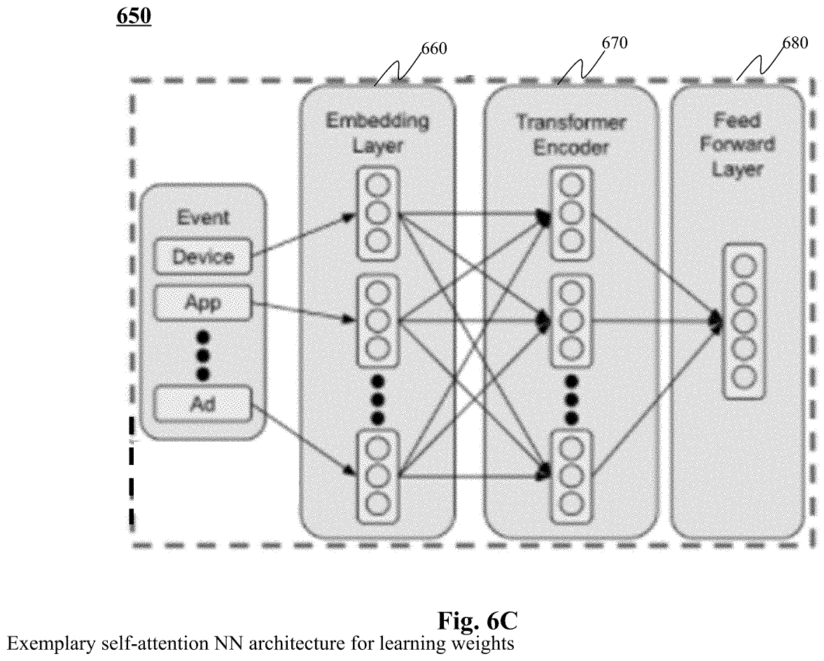

Implementation of the ANN 490 may be of any deep learning neural network architecture, whether existing today or developed in the future. FIGS. 6A-6B present some exemplary implementation of the ANN 490 for learning event embeddings. Such specific structures of the exemplary architectures are merely for illustration and do not serve as limitations of the present teaching. FIG. 6A depicts an exemplary architecture 600 for the ANN 490 for learning raw event embeddings, in accordance with an exemplary embodiment of the present teaching. In this architecture 600, there are three layers, namely an input embedding layer 610, a transformer/encoder layer 620, and an output embedding layer 630. The sequence of events with gaps is fed into the input embedding layer 610. The outputs of the input embedding layer are fed to the transformer layer 620, which is connected to the output embedding layer 630.

The input embedding layer 610 may have sub-networks, each for an event or gap in an input sequence. Each sub-network may be further structured for event and/or gap. FIG. 6B shows an exemplary sub-network 640 for encoding a gap in an input sequence. FIG. 6C shows an exemplary sub-network 650 for encoding an event in an input sequence. In this illustrated embodiment, the sub-network 650 comprises an embedding layer 640, a transformer encoder 650, and a feed forward layer 660. Each event may further include various entities in an event such as a device, an application, . . . , an advertisement, a user, etc. As discussed herein, in the framework of the present teaching, each event in a sequence is treated as a word in a sentence (corresponding to a sequence) while such entities in each event are treated as letters of a word. Utilizing the framework of word2vec, each letter of a word is individually fed to the embedding layer 640. As shown in FIG. 2C, each letter or entity is fully connected to other letters in the word. This is also shown in FIG. 6C between the embedding layer 640 and the transform encoder 650. The output of the transformer encoder is then sent to the feed forward layer 660, as shown in FIG. 6C. Combining FIGS. 6A-6C, each of the events/gaps in an input sequence is learned via a sub-network as shown in FIG. 6B (for a gap) or FIG. 6C (for an event) so the corresponding embedding can be learned. The output of the feed forward layer corresponding to each event is then sent to a sub-network for it in the output embedding layer 630.

Overall, the input embedding layer 610 is provided to learn embeddings of each event in an input sequence of events. That is, once learned, it generates embeddings (or features) for each of the events in an input sequence. The transformer layer 620 is provided to, e.g., leverage self-attention to capture relations among entities of each event. In some embodiments, as illustrated, it may include a position specific feedforward layer, as shown in FIG. 6C. In some embodiments, it is also possible to deploy a globally shared feedforward layer. Having a position specific feed forward layer may be appropriate when fixed types of entities are known to be at corresponding positions. In some embodiments, the transformer may be implemented using the BERT architecture.

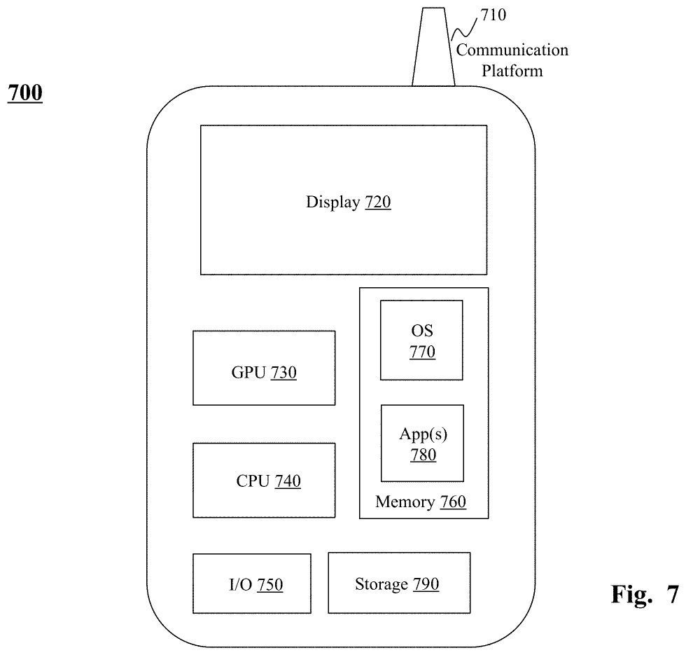

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but is not limited to, a smart phone, a tablet, a music player, a handled gaming console, a global positioning system (GPS) receiver, and a wearable computing device (e.g., eyeglasses, wristwatch, etc.), or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 740. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a browser or any other suitable mobile apps for managing a system according to the present teaching on mobile device 700. User interactions, if any, may be achieved via the I/O devices 740 and provided to the various components connected via network(s).

To implement various modules, units, and their functionalities described in the present disclosure, computer hardware platforms may be used as the hardware platform(s) for one or more of the components/elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

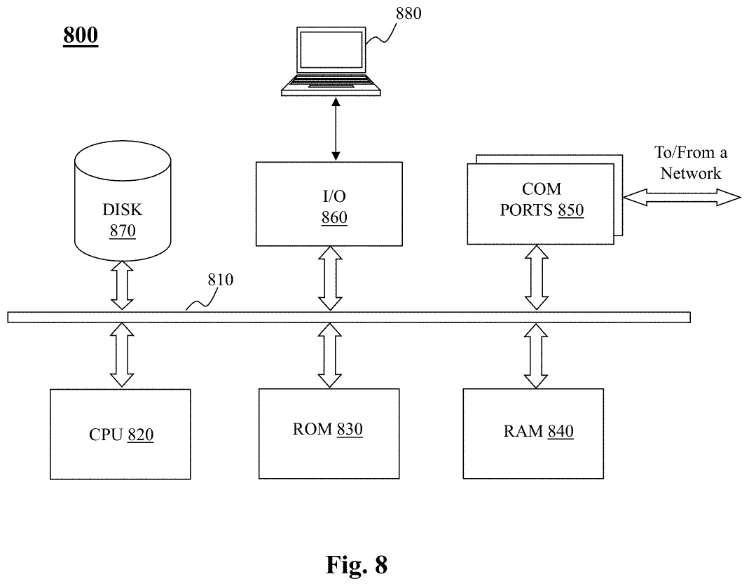

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general purpose computer or a special purpose computer. Both can be used to implement a specialized system for the present teaching. This computer 800 may be used to implement any component or aspect of the framework as disclosed herein. For example, the system as disclosed herein may be implemented on a computer such as computer 800, via its hardware, software program, firmware, or a combination thereof. Although only one such computer is shown, for convenience, the computer functions relating to the present teaching as described herein may be implemented in either a centralized or a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of dialogue management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with conversation management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (TR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the fraudulent network detection techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine including at least one processor, memory, and communication platform capable of connecting to a network for learning embeddings, the method comprising:
receiving raw event data recording information related to a plurality of events;
identifying at least one attribute associated with each of the plurality of events from the raw event data, wherein the at least one attribute represent characteristics associated with the event;
grouping the plurality of events into one or more aggregated groups in accordance with an aggregation criterion, wherein each of the one or more groups includes at least one of the plurality of events that satisfies the aggregation criterion;
creating, for each of the one or more aggregated groups, an event sequence comprising at least one event from the aggregated group and one or more gaps each of which separates a pair of adjacent events in the at least one event;
learning, via an artificial neural network (ANN), event embeddings based on event sequences generated with respect to the one or more aggregated groups, wherein
the aggregation criterion is defined with respect to one or more types of attributes identified from the plurality of events.

2. The method of claim 1, wherein the at least one attribute associated with an event includes at least one of one or more entities, an action performed in the event, and additional peripheral attributes associated with the event.

3. The method of claim 2, wherein the event is an online event associated with online advertising and describes:
a user,
an advertisement;
an action performed by the user on the advertisement; and
optionally an online source where the advertisement is presented to the user, a user agent that the user operates to take the action, and additional peripheral information surrounding the event.

4. The method of claim 3, wherein
each of the event sequences is represented as a hypergraph;
an event in the event sequence is represented as a hyperedge in the hypergraph, capturing relationships among different entities involved in the event.

5. The method of claim 1, wherein the ANN network is structured for learning word embeddings so that each of the event sequences is treated as a sentence of words and with each event in the event sequence treated as a word in the sentence.

6. The method of claim 1, further comprising:
receiving task-based supervision configurations providing classification instructions with respect to the plurality of events;
retrieving event embeddings for the plurality of events; and
obtaining one or more task-based models via machine learning based on the event embeddings and the task-based supervision configurations.

7. The method of claim 6, further comprising:
receiving input data related to an input event;
classifying, based on the one or more task-based models, the input event.

8. Machine readable and non-transitory medium having information recorded thereon for learning embeddings, wherein the information, when read by the machine, causes the machine to perform the following steps:
receiving raw event data recording information related to a plurality of events;
identifying at least one attribute associated with each of the plurality of events from the raw event data, wherein the at least one attribute represent characteristics associated with the event;
grouping the plurality of events into one or more aggregated groups in accordance with an aggregation criterion, wherein each of the one or more groups includes at least one of the plurality of events that satisfies the aggregation criterion;
creating, for each of the one or more aggregated groups, an event sequence comprising at least one event from the aggregated group and one or more gaps each of which separates a pair of adjacent events in the at least one event;
learning, via an artificial neural network (ANN), event embeddings based on event sequences generated with respect to the one or more aggregated groups, wherein
the aggregation criterion is defined with respect to one or more types of attributes identified from the plurality of events.

9. The medium of claim 8, wherein the at least one attribute associated with an event includes at least one of one or more entities, an action performed in the event, and additional peripheral attributes associated with the event.

10. The medium of claim 9, wherein the event is an online event associated with online advertising and describes:
a user,
an advertisement;
an action performed by the user on the advertisement; and
optionally an online source where the advertisement is presented to the user, a user agent that the user operates to take the action, and additional peripheral information surrounding the event.

11. The medium of claim 10, wherein
each of the event sequences is represented as a hypergraph;
an event in the event sequence is represented as a hyperedge in the hypergraph, capturing relationships among different entities involved in the event.

12. The medium of claim 8, wherein the ANN network is structured for learning word embeddings so that each of the event sequences is treated as a sentence of words and with each event in the event sequence treated as a word in the sentence.

13. The medium of claim 8, wherein the information, when read by the machine, further causes the machine to perform the following steps:
receiving task-based supervision configurations providing classification instructions with respect to the plurality of events;
retrieving event embeddings for the plurality of events; and
obtaining one or more task-based models via machine learning based on the event embeddings and the task-based supervision configurations.

14. The medium of claim 13, wherein the information, when read by the machine, further causes the machine to perform the following steps:
receiving input data related to an input event;
classifying, based on the one or more task-based models, the input event.

15. A system for learning embeddings, comprising:
an identifier implemented by a processor and configured for, identifying at least one attribute associated with each of a plurality of events recorded in raw event data, wherein the at least one attribute represent characteristics associated with the event;
an event data aggregator implemented by the processor and configured for grouping the plurality of events into one or more aggregated groups in accordance with an aggregation criterion, wherein each of the one or more groups includes at least one of the plurality of events that satisfies the aggregation criterion;
an event sequence creator implemented by the processor and configured for creating, for each of the one or more aggregated groups, an event sequence comprising at least one event from the aggregated group and one or more gaps each of which separates a pair of adjacent events in the at least one event;
an artificial neural network (ANN) configured for learning event embeddings based on event sequences generated with respect to the one or more aggregated groups, wherein
the aggregation criterion is defined with respect to one or more types of attributes identified from the plurality of events.

16. The system of claim 15, wherein the identifier for identifying the at least one attribute includes:
an entity identifier configured for identifying one or more entities from each of the plurality of events;
an action identifier configured for identifying an action performed in each of the event plurality of events; and
a peripheral attribute identifier configured for identifying additional peripheral attributes associated with each of the plurality of events.

17. The system of claim 16, wherein an event is an online event associated with online advertising and describes:
a user,
an advertisement;
an action performed by the user on the advertisement; and
optionally an online source where the advertisement is presented to the user, a user agent that the user operates to take the action, and additional peripheral information surrounding the event.

18. The system of claim 17, wherein
each of the event sequences is represented as a hypergraph;
an event in the event sequence is represented as a hyperedge in the hypergraph, capturing relationships among different entities involved in the event.

19. The system of claim 15, further comprising an event-embedding based task model generator implemented by a processor and configured for:
receiving task-based supervision configurations providing classification instructions with respect to the plurality of events;
retrieving event embeddings for the plurality of events; and
obtaining one or more task-based models via machine learning based on the event embeddings and the task-based supervision configurations.

20. The system of claim 19, further comprising a task-specific classifier implemented by a processor and configured for:
receiving input data related to an input event;
classifying, based on the one or more task-based models, the input event.
